(19) United States
(12) Patent Application Publication
(10) Pub. No.: US 2012/0086218 A1
(43) Pub. Date: Apr. 12, 2012

(54) METHOD FOR GENERATING ELECTRICAL ENERGY AND USE OF A WORKING SUBSTANCE

(76) Inventors: Ewa Bozek, Karlsruhe (DE); Michael Fenz, Erlangen (DE); Klaus Himmler, Hammersbach (DE); Ralph Joh, Seligenstadt (DE); Jörg Lengert, Lonnerstadt-Ailsbach (DE)

(21) Appl. No.: 13/318,902

(22) PCT Filed: Apr. 15, 2010
(86) PCT No.: PCT/EP10/54969

§ 371 Date: Dec. 29, 2011

(30) Foreign Application Priority Data
May 7, 2009 (DE) 10 2009 020 268.4

(51) Int. Cl. F01K 25/08; F03G 4/00; H02K 7/18

(52) U.S. Cl. 290/1 R; 60/651; 60/641.2

(57) ABSTRACT

In a method for generating electrical energy by means of at least one low-temperature heat source (2), a VPT cyclic process (1, 10, 100) is carried out. Certain working substances are used to increase the efficiency of the VPT cyclic process.

### CROSS-REFERENCE TO RELATED APPLICATIONS

This application is a U.S. National Stage Application of International Application No. PCT/EP2010/054969 filed Apr. 15, 2010, which designates the United States of America, and claims priority to German Application No. 10 2009 020 268.4 filed May 7, 2009. The contents of which are hereby incorporated by reference in their entirety.

### TECHNICAL FIELD

The invention relates to a method for generating electric energy by means of at least one low-temperature heat source, with a VPT cyclic process being carried out.

### BACKGROUND

Owing to constantly increasing energy prices throughout the world, systems for utilizing waste heat even within a low-temperature range of up to 400° C. in the form of, for instance, geothermal energy or waste heat from an industrial process are gaining ever more importance.

Heat from a low-temperature heat source is utilized more intensively using a VPT cyclic process than is the case with a conventional ORC (ORC: Organic Rankine Cycle) process employing organic, often environmentally harmful working substances, or with what is termed a Kalina cycle, which is technically complex and uses an ammonia-water mixture as the working substance.

A VPT cyclic process is based on a turbine (VPT: Variable Phase Turbine) that can be driven by means of a gaseous or liquid phase or a mixture of a gaseous and liquid phase. A turbine of such kind is known from U.S. Pat. No. 7,093,503 B1.

U.S. Pat. No. 7,093,503 B1 discloses in FIG. 7 a method for generating electric energy by means of at least one low-temperature heat source, with a VPT cyclic process being carried out. Serving therein as a low-temperature heat source is a fluid that is heated by means of geothermal energy and transfers heat to a working substance. The working substance is fed to the turbine and expanded by means of a nozzle. The produced jet of working substance has kinetic energy which drives a rotor of a generator with electric energy being produced in the process. The working substance (gaseous or gaseous/liquid) is cooled and condensed and ducted via a pump by means of which the pressure in the working substance is increased. The working substance is then according to U.S. Pat. No. 7,093,503 B1 all fed back again to the turbine for cooling the generator and lubricating the seals in the turbine. When the working substance has left the turbine, heat is again transferred to it by the fluid heated by means of geothermal energy and the circuit thus closed.

In an operating mode not proceeding from U.S. Pat. No. 7,093,503 B1, the generator and seals in the turbine can be respectively cooled and lubricated also by feeding only a part of the working substance back to the turbine for cooling the generator and lubricating the seals in the turbine. The part that is branched away to the turbine will after leaving it be recombined with the rest of the working substance. The circuit will be closed by then transferring heat to the working substance again by means of the fluid heated by the geothermal energy. Thus here, too, a cyclic process will be referred to as a VPT cyclic process in which the working substance, behind the pump, is fed only partially to the turbine once again.

In another operating mode not proceeding from U.S. Pat. No. 7,093,503 B1, the generator and seals in the turbine can be respectively cooled and lubricated also by way of a separate lubricating and/or cooling cycle. Thus here, too, a cyclic process will be referred to as a VPT cyclic process in which the working substance, behind the pump, is fed directly to a process whereby it is heated by the fluid heated by means of geothermal energy and the circuit will hence be closed without the working substance's being fed to the turbine once again.

The working substance circulates in a closed system. It therein passes through a heat-exchanging region, in which heat from the low-temperature heat source is transferred to the working substance, through the turbine, through a condensing region, through a pump, and optionally completely or partially through the turbine again to finally be fed back to the heat-exchanging region and pass through the cyclic system again.

R134a (1,1,1,2-tetrafluorethane) and R245fa (1,1,1,3,3-penta-fluoropropane) are described in U.S. Pat. No. 7,093,503 B1 as working substances for a VPT cyclic process.

R245ca (1,1,2,2,3-pentafluoropropane) is furthermore also cited on the internet site of the company Energent (http://www.energent.net/Projects%20VPT.htm) as a working substance for use in a VPT cyclic process.

However, only efficiency levels of less than 11.5% can be achieved with known working substances in the VPT cyclic process referred to a working-substance temperature of around 115° C., meaning that less than 11.5% of the available thermal energy will be converted into electric energy.

### SUMMARY

According to various embodiments, the efficiency level of a method for generating electric energy by means of at least one low-temperature heat source, with a VPT cyclic process being carried out can be raised.

According to an embodiment, in a method for generating electric energy by means of at least one low-temperature heat source, with a VPT cyclic process being carried out, as a working substance for the VPT cyclic process a) at least one substance from the group that includes cycloalkane, alkenes, dienes, or alkines having two to six carbon atoms is used, or b) at least one alkane from the group that includes 1-chloro-1,2,2,2-tetrafluoroethane, 1-chloro-1,l-difluoroethane, methyl chloride, bromodifluoromethane, iodotrifluoromethane, and 2-methylpropane, or c) at least one ether having two carbon atoms is used.

According to a further embodiment, a substance from the group that includes cyclopropane, trans-2-butene, isobutene, 1-chloro-2,2-difluoroethylene, 1,2-butadiene, 1,3-butadiene, propadiene, propine, iodotrifluoromethane, and dimethyl ether can be used as the working substance for the VPT cyclic process. According to a further embodiment, a substance from the group that includes cyclopropane, propadiene, propine, iodotrifluoromethane, and dimethyl ether can be used as the working substance for the VPT cyclic process.

According to another embodiment, in a method for generating electric energy by means of at least one low-temperature heat source, with a VPT cyclic process being carried out, at least one substance having a fugacity exceeding 17 bar in the liquid phase at a temperature of 115° C. can be used as the working substance for the VPT cyclic process.

According to a further embodiment of the above method, a substance from the group that includes 1-chloro-1,2,2,2-tetra-fluoroethane, 1-chloro-1, 1difluoroethane, 2-methylpropane, iso-butene, cyclopropane, propadiene, propine, and dimethyl ether can be used as the working substance for the VPT process.

According to a further embodiment of any of the above methods, the low-temperature heat source makes temperatures in the 90-to-400° C. range available. According to a further embodiment of any of the above methods, the low-temperature heat source can make temperatures in the 100-to-250° C. range available. According to a further embodiment of any of the above methods, the low-temperature heat source can be provided by means of geothermal energy or waste heat from an industrial process.

According to yet another embodiment, a working substance in the form of a) at least one substance from the group that includes cycloalkanes, alkenes, dienes, or alkines having two to six carbon atoms, or b) at least one alkane from the group that includes 1-chloro-1,2, 2-tetrafluoroethane, 1-chloro-1,1-difluoroethane, methyl chloride, bromodifluoromethane, iodotrifluoromethane, and 2-methylpropane, or c) at least one ether having two carbon atoms can be used for a VPT cyclic process for generating electric energy by means of at least one low-temperature heat source.

According to yet another embodiment, a working substance in the form of at least one substance having a fugacity exceeding 17 bar in the liquid phase at a temperature of 115° C. can be used for a VPT cyclic process for generating electric energy by means of at least one low-temperature heat source.

According to a further embodiment of the above use, the at least one substance may have a fugacity exceeding 20 bar, in particular exceeding 25 bar, in the liquid phase at a temperature of 115° C. According to a further embodiment of any of the above uses, a temperature in the 90-to-400° C. range, particularly the 100-to-250° C. range, can be made available by the low-temperature heat source.

### BRIEF DESCRIPTION OF THE DRAWINGS

FIGS. 1 to 4 show exemplary VPT cyclic processes:

FIG. 1 shows a first VPT cyclic process;

FIG. 2 shows a second VPT cyclic process;

FIG. 3 shows a third VPT cyclic process; and

FIG. 4 shows a fourth VPT cyclic process.

### DETAILED DESCRIPTION

According to various embodiments, in a first method for generating electric energy by means of at least one low-temperature heat source, a VPT cyclic process being carried out, by using as the working substance for the VPT cyclic process

a) at least one substance from the group that includes cycloalkanes, alkenes, dienes, or alkines having two to six carbon atoms, or

b) at least one alkane from the group that includes 1-chloro-1,2,2,2-tetrafluoroethane, 1-chloro-1,1-difluoroethane, methyl chloride, bromodifluoromethane, iodotrifluoromethane, and 2-methylpropane, or

c) at least one ether having two carbon atoms.

According to other embodiments, in a second method for generating electric energy by means of at least one low-temperature heat source, a VPT cyclic process being carried out, with at least one substance having a fugacity exceeding 17 bar in the liquid phase at a temperature of 115° C. being used as the working substance for the VPT cyclic process.

What is therein understood by a VPT cyclic process is any cyclic process that includes a VPT turbine able to be driven by means of a gaseous as well as a liquid phase and also a mixture of a gaseous and liquid phase.

For a working substance to be present in a liquid phase its pressure may have to be raised accordingly by means of, for example, a pump. Centrifugal pumps are particularly preferred for that purpose.

Those methods result in an increase in the efficiency level to values of 12% and above.

A preferred cycloalkane in terms of the first method is cyclo-propane. Particularly suitable alkenes are trans-2-butene or 1-chloro-2,2-difluoroethylene. 1,2-butadiene, 1,3-butadiene, or propadiene are particularly suitable as dienes. A preferred alkine is propine. A particularly preferred ether is dimethyl ether.

In terms of the second method, a substance from the group that includes 1-chloro-1,2,2,2-tetrafluoroethane, 1-chloro-1,1-difluoroethane, 2-methylpropane, isobutene, cyclopropane, propadiene, propine, and dimethyl ether is preferably used as the working substance for the VPT process. Thus 1-chloro-1,2,2,2-tetrafluoroethane has a fugacity of 21.6 bar, 1-chloro-1,1-difluoroethane a fugacity of 19.9 bar, 2-methylpropane a fugacity of 19.2 bar, isobutene a fugacity of 17.9 bar, cyclopropane a fugacity of 32.6 bar, propadiene a fugacity of 31.3 bar, propine a fugacity of 30.1 bar, and dimethyl ether a fugacity of 29.9 bar in the liquid phase at 115° C.

It is particularly advantageous if in terms of the second method at least one substance having a fugacity exceeding 20 bar, particularly preferably exceeding 25 bar, in the liquid phase at a temperature of 115° C. is used as the working substance for the VPT cyclic process.

Of the substances cited, in terms of environmental factors particularly the substances that are halogen-free are preferred for both methods.

The use of pure substances as working substances is furthermore preferred to the use of working-substance mixtures because expenditure requirements in terms of technical equipment for a system for carrying out a VPT cyclic process will be reduced thereby.

A substance from the group that includes cyclopropane, trans-2-butene, 1-chloro-2,2-difluoroethylene, 1-chloro-1,2,2,2-tetra-fluoroethane, bromodifluoromethane, 1-chloro-1,1-difluoro-ethane, propadiene, propine, methyl chloride, iodotrifluoro-methane, and dimethyl ether is preferably used as the working substance for the VPT process. An increase in the efficiency level to values of 12.5% and above will result therefrom.

Particularly a substance from the group that includes cyclopropane, propadiene, propine, iodotrifluoromethane, and dimethyl ether is used as the working substance for the VPT cyclic process. An increase in the efficiency level to values of 13% and above can be achieved thereby.

The use of dimethyl ether, propine, propadiene, or iodotrifluoromethane is particularly preferred. The effect thereof is that the efficiency level can be increased to values of 13.5% and above.

An efficiency level of 14% and above can be advantageously achieved by using propadiene as the working substance.

A use of a working substance in the form of

a) at least one substance from the group that includes cycloalkanes, alkenes, dienes, or alkines having two to six carbon atoms, or

b) at least one alkane from the group that includes 1-chloro-1,2,2,2-tetrafluoroethane, 1-chloro-1,1-difluoroethane, methyl chloride, bromodifluoromethane, iodotrifluoromethane, and 2 methylpropane, or

c) at least one ether having two carbon atoms, for a VPT cyclic process for generating electric energy by means of at least one low-temperature heat source is ideal.

A use of a working substance in the form of at least one substance which in the liquid phase at a temperature of 115° C. has a fugacity exceeding 17 bar for a VPT cyclic process for generating electric energy by means of at least one low-temperature heat source is furthermore also ideal.

It has proved expedient for the low-temperature heat source to make temperatures available in the 90-to-400° C. range, particularly the 100-to-250° C. range. Low-temperature heat sources having temperatures in the 100-to-150° C. range are furthermore particularly preferred.

A low-temperature heat source is provided preferably by means of geothermal energy, with low boring depths in the ground already sufficing to make waste heat available in the 90-to-250° C. range.

A low-temperature heat source can, though, alternatively be provided also by means of waste heat from an industrial process. Industrial processes producing usable waste heat are based on, for instance, chemical reactions or heat-treatment processes, etc., as are frequently encountered in the chemical or pharmaceutical industry, in the steel industry, or the paper industry, etc.

A temperature difference of at least 5° C., particularly at least 10° C., between the medium provided by the low-temperature heat source and the working substance is preferred in the heat-exchanging region.

Tables 1 to 3 compare a number of working substance in terms of their gross efficiency level, with the working substances having been heated in a VPT cyclic process from a low-temperature heat source to a temperature of 115° C. The temperature of the working substance was therein determined immediately after the transfer of heat from the low-temperature heat source to the working substance.

The tables below therein show working substances (in bold type) already known for use in a VPT cyclic process as well as by way of example a selection of other working substances, selected ones from among which result in higher levels of efficiency.

In the tables, Tₖᵣ=critical temperature.

The formula for the gross efficiency level is:

η=(W_{Turbine}/Q_{geothermal})·100%

where

W_{Turbine}=Work done by the turbine (in J), the work to be taken as an absolute value

Q_{geothermal}=Heat at the boundary between low-temperature heat source and working substance (in J)

TABLE 1
Working substances in the form of alkenes compared
with known working substances

| | | | Gross |
|---|---|---|---|
| | | | efficiency |
| | Total | Tₖᵣ | level as a |
| Working substance | formula | [° C.] | % at 115° C. |
| 1,1,1,3,3-pentafluoropropane | C3H3F5 | 157.5 | 11.44 |
| [R245fa] | | | |
| 1,1,2,2,3-pentafluoropropane | C3H3F5 | 174.42 | 9.31 |
| [R245ca] | | | |
| 1-chloro-2,3- | C2HClF2 | 127.4 | 12.59 |
| difluoroethylene [R1122] | | | |
| 2-trans-butene | C4H8 | 155.45 | 12.77 |
| Isobutene | C4H8 | 149.25 | 12.04 |

TABLE 2
Comparison of working substances in the form of al-
kanes

| | | | Gross |
|---|---|---|---|
| | | | efficiency |
| | Total | Tₖᵣ | level as a |
| Working substance | formula | [° C.] | % at 115° C. |
| 1,1,1,3,3-pentafluoropropane | C3H3F5 | 157.5 | 11.44 |
| [R245fa] | | | |
| 1,1,2,2,3-pentafluoropropane | C3H3F5 | 174.42 | 9.31 |
| [R245ca] | | | |
| Methyl chloride [R40] | CH3Cl | 143.15 | 12.87 |
| Bromodifluoromethane [R22B1] | CHBrF2 | 138.83 | 12.82 |
| Iodotrifluoromethane | CF3I | 123.29 | 13.57 |
| Dichloromethane [R21] | CHCl2F4 | 178.45 | 11.02 |
| 1,1- | C2Cl2F4 | 145.5 | 11.2 |
| dichlorotetrafluoroethane | | | |
| [R114a] | | | |
| 1,2- | C2Cl2F4 | 145.7 | 11.5 |
| dichlorotetrafluoroethane | | | |
| [R114] | | | |
| 1-chloro-1,2,2,2- | C2HClF4 | 122.5 | 12.72 |
| tetrafluoroethane [R124] | | | |
| 1-chloro-1,1-difluoroethane | C2H3ClF4 | 137.2 | 12.63 |
| [R142b] | | | |
| 1,1,1,3,3,3- | C3H2F6 | 124.92 | 11.86 |
| hexafluoropropane [R236fa] | | | |
| 1,1,1,2,3,3- | C3H2F6 | 139.23 | 10.95 |
| hexafluoropropane [R236ea] | | | |
| Cyclopropane | C3H6 | 124.85 | 13.18 |
| 2-methylpropane | C4H10 | 135.65 | 12.43 |
| n-butane [R600] | C4H10 | 152.05 | 11.87 |
| Perfluoropentane | C5F12 | 147.44 | 8.5 |

TABLE 3
Working substances in the form of dienes, alkines, or
ethers compared with known working substances

| | | | Gross |
|---|---|---|---|
| | | | effi- |
| | | | ciency |
| | | | level as |
| | Total | Tₖᵣ | a % at |
| Working substance | formula | [° C.] | 115° C. |
| 1,1,1,3,3-pentafluoropropane | C3H3F5 | 157.5 | 11.44 |
| [R245fa] | | | |
| 1,1,2,2,3-penatfluoropropane | C3H3F5 | 174.42 | 9.31 |
| [R245ca] | | | |
| Propadiene | C3H4 | 120.75 | 14.22 |
| 1,2-butadiene | C4H6 | 170.55 | 12.01 |
| 1,3-butadiene | C4H6 | 151.85 | 12.36 |
| Propine | C3H4 | 129.25 | 13.66 |
| Dimethyl ether | C2H60 | 126.85 | 13.54 |

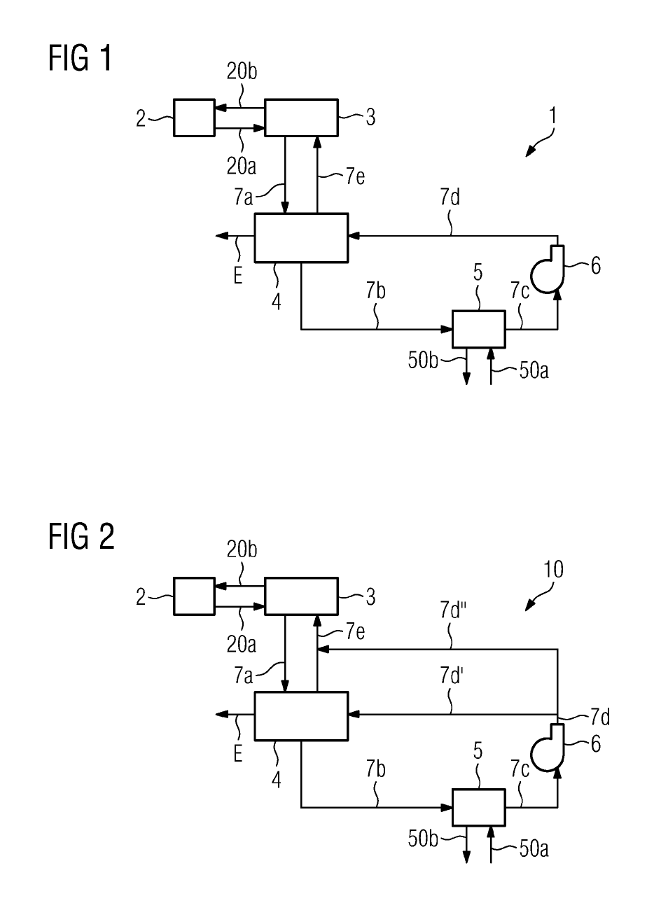

FIG. 1 shows a first VPT cyclic process 1. There is a low-temperature heat source 2 that makes a fluid 20a heated by means of geothermal energy or waste heat from an industrial process available. A fluid made available by means of geothermal energy is in particular thermal water. Heated fluid 20a passes through a heat-exchanging region 3 in which heated fluid 20a transfers a part of the thermal energy stored in it to a working substance 7e which likewise passes through heat-exchanging region 3. For example propadiene, dimethyl ester, cyclopropane, propine, or iodotrifluoromethane is used as working substance 7e. Heat-exchanging region 3 is, for example, a heat exchanger, in particular a cross-flow or counter-flow heat exchanger. Working substance 7a heated by means of heated fluid 20a passes from heat-exchanging region 3 into a “variable-phase” turbine 4 (VPT) and is expanded there by means of a nozzle.

The produced jet of working substance 7b has kinetic energy which drives a rotor of a generator with electric energy E being generated in the process. Working substance 7b which is present in at least partially gaseous form is cooled and condensed in a condensing region 5. A coolant 50a in the form of, for instance, cooling water or cooling air is fed to condensing region 5 for cooling working substance 7b and leaves condensing region 5 again as heated coolant 50b. Direct or hybrid cooling can alternatively also be used for cooling in condensing region 5. Condensed working substance 7c is ducted via a pump 6 by means of which the pressure in working substance 7c is increased. Working substance 7d that is under greater pressure or, as the case may be, compressed is then all fed back again to turbine 4 for cooling the generator and lubricating the seals in turbine 4. When working substance 7e has left the turbine, heat is again transferred to it by fluid 20a heated by means of geothermal energy or waste heat from an industrial process and the circuit thus closed.

FIG. 2 shows a second VPT cyclic process 10. The same reference numerals/letters used in FIG. 1 and FIG. 2 correspond to the same units. For example propadiene, dimethyl ester, cyclopropane, propine, or iodotrifluoromethane is used as working substance 7e. From heat-exchanging region 3 to attaining pump 6, the flow of operations shown in FIG. 2 therein corresponds to that already described in connection with FIG. 1. Condensed working substance 7c is here, too, ducted via pump 6 by means of which the pressure in working substance 7c is increased. Working substance 7d that is under greater pressure is then divided into a first partial flow 7d′ and a second partial flow 7d″. First partial flow 7d′ is again fed to turbine 4 for cooling the generator and lubricating the seals in turbine 4. After leaving turbine 4, the first partial flow is combined with second partial flow 7d″. Heat is again transferred by fluid 20a heated by means of geothermal energy or waste heat from an industrial process to working substance 7e that is formed in total and the circuit thus closed.

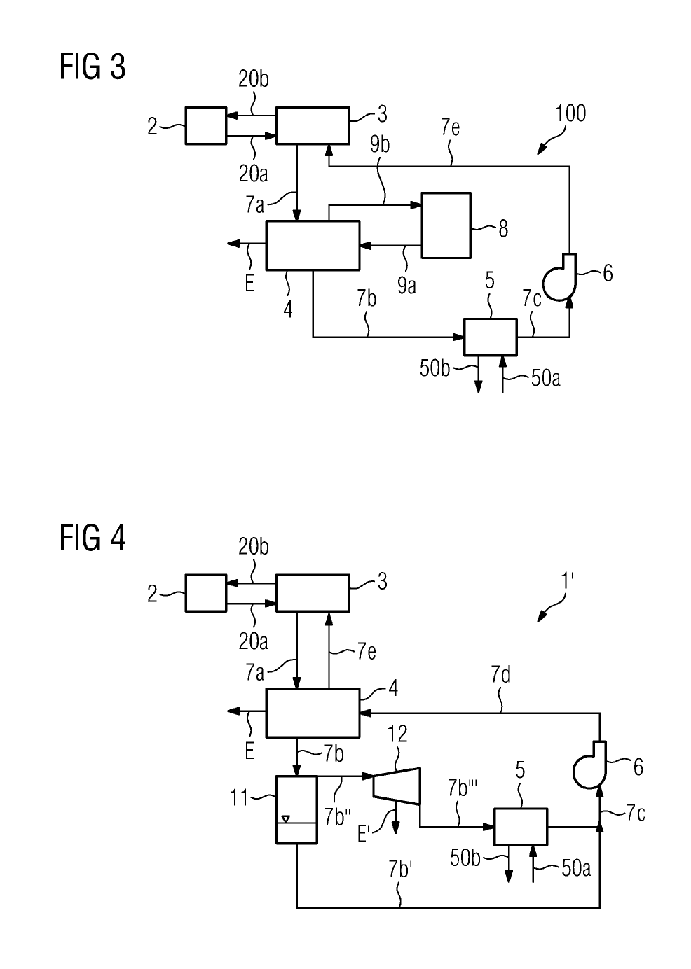

FIG. 3 shows a third VPT cyclic process 100. The same reference numerals/letters used in FIGS. 1 to 3 correspond to the same units. For example propadiene, dimethyl ester, cyclopropane, propine, or iodotrifluoromethane is used as working substance 7e. From heat-exchanging region 3 to attaining pump 6, the flow of operations shown in FIG. 3 therein corresponds to that already described in connection with FIG. 1. Condensed working substance 7c is here, too, ducted via pump 6 by means of which the pressure in working substance 7c is increased. Working substance 7d that is under greater pressure is then immediately fed back to heat-exchanging region 3. Heat is again transferred by fluid 20a heated by means of geothermal energy or waste heat from an industrial process to working substance 7e and the circuit thus closed. A separate coolant and lubricant circuit 8 that feeds a coolant and lubricant 9a, 9b to turbine 4 and away from it again separately from the working-substance cycle is provided for cooling the generator and lubricating the seals in turbine 4.

FIG. 4 shows a fourth VPT cyclic process 1′. There is a low-temperature heat source 2 that makes a fluid 20a heated by means of geothermal energy or waste heat from an industrial process available. A fluid made available by means of geothermal energy is in particular thermal water. Heated fluid 20a passes through a heat-exchanging region 3 in which heated fluid 20a transfers a part of the thermal energy stored in it to a working substance 7e which likewise passes through heat-exchanging region 3. For example propadiene, dimethyl ester, cyclopropane, propine, or iodotrifluoromethane is used as working substance 7e. Heat-exchanging region 3 is, for example, a heat exchanger, in particular a cross-flow or counter-flow heat exchanger. Working substance 7a heated by means of heated fluid 20a passes from heat-exchanging region 3 into a “variable-phase” turbine 4 (VPT) and is expanded there by means of a nozzle.

The produced jet of working substance 7b has kinetic energy which drives a rotor of a generator with electric energy E being generated in the process. Working substance 7b which is present in at least partially gaseous form is fed to a cutter 11 in which working substance 7b′ present in a liquid phase is separated from working substance 7h″ present in a gaseous phase. Working substance 7b″ present in a gaseous phase is fed to a gas turbine 12 by means of which more electric energy E′ is generated. After gas turbine 12, working substance 7b′″ that is present at least partially in gaseous form is condensed in a condensing region 5. A coolant 50a in the form of, for instance, cooling water or cooling air is fed to condensing region 5 for cooling working substance 7b and leaves condensing region 5 again as heated coolant 50b. Direct or hybrid cooling can alternatively also be used for cooling in condensing region 5. Condensed working substance 7c condensed in condensing region 5 is ducted with the portion of liquid working substance 7b′ separated off in cutter 11 via a pump 6 by means of which the pressure in working substance working substance 7c, 7b′ is increased. Working substance 7d that is under greater pressure or, as the case may be, compressed is then all fed back again to turbine 4 for cooling the generator and lubricating the seals in turbine 4. When working substance 7e has left the turbine, heat is again transferred to it by fluid 20a heated by means of geothermal energy or waste heat from an industrial process and the circuit thus closed.

The VPT cyclic processes shown by way of example in FIGS. 1 to 4 can, however, be readily further modified by a person skilled in the relevant art. Thus, for example, condensing region 5 can likewise be supplied with coolant 50a via a coolant circuit and suchlike. It is furthermore possible, for example, to dispense with gas turbine 12 in FIG. 4 so that working substance 7b″ present in a gaseous phase will be fed directly from cutter 11 into condensing region 5. Another cutter could in FIG. 4 be located between gas turbine 12 and condensing region 5 in order to feed the working substance present in a liquid phase directly to pump 6 so that behind gas turbine 12 only working substance present in a gaseous phase will be fed to condensing region 5. There can furthermore be control valves, pressure-control valves, and pressure-gauging devices etc. in a VPT cyclic process.

What is claimed is:

1. A method for generating electric energy by means of at least one low-temperature heat source comprising:
carrying out a VPT cyclic process wherein as a working substance for the VPT cyclic process
a) at least one substance from the group that includes cycloalkane, alkenes, dienes, or alkines having two to six carbon atoms is used, or
b) at least one alkane from the group that includes 1-chloro1,2,2,2-tetrafluoroethane, 1-chloro-1,1-difluoroethane, methyl chloride, bromodifluoromethane, iodotrifluoromethane, and 2-methylpropane, or
c) at least one ether having two carbon atoms is used.

2. The method according to claim 1, wherein substance from the group that includes cyclopropane, trans-2-butene, isobutene, 1-chloro-2,2-difluoroethylene, 1,2-butadiene, 1,3-butadiene, propadiene, propine, iodotrifluoromethane, and dimethyl ether is used as the working substance for the VPT cyclic process.

3. The method according to claim 1, wherein a substance from the group that includes cyclopropane, propadiene, propine, iodotrifluoromethane, and dimethyl ether is used as the working substance for the VPT cyclic process.

4. A method for generating electric energy by means of at least one low-temperature heat source, comprising:
carrying out a VPT cyclic process, wherein at least one substance having a fugacity exceeding 17 bar in the liquid phase at a temperature of 115° C. is used as the working substance for the VPT cyclic process.

5. The method according to claim 4, wherein a substance from the group that includes 1-chloro-1,2,2,2-tetrafluoroethane, 1-chloro-1,1difluoroethane, 2-methylpropane, isobutene, cyclopropane, propadiene, propine, and dimethyl ether is used as the working substance for the VPT process.

6. The method according to claim 4, wherein the low-temperature heat source makes temperatures in the 90-to-400° C. range available.

7. The method according to claim 4, wherein the low-temperature heat source makes temperatures in the 100-to-250° C. range available.

8. The method according to claim 4, wherein the low-temperature heat source
is provided by means of geothermal energy or waste heat from an industrial process.

9. A method for using of a working substance, comprising using the working substance in the form of
a) at least one substance from the group that includes cycloalkanes, alkenes, dienes, or alkines having two to six carbon atoms, or
b) at least one alkane from the group that includes 1-chloro-1,2, 2-tetrafluoroethane, 1-chloro-1,1-difluoroethane, methyl chloride, bromodifluoromethane, iodotrifluoromethane, and 2-methylpropane, or
c) at least one ether having two carbon atoms
for a VPT cyclic process for generating electric energy by means of at least one low-temperature heat source.

10. A method for using of a working substance comprising:
using the working substance in the form of at least one substance having a fugacity exceeding 17 bar in the liquid phase at a temperature of 115° C. for a VPT cyclic process for generating electric energy by means of at least one low-temperature heat source.

11. The method according to claim 10, wherein the at least one substance having a fugacity exceeding 20 bar in the liquid phase at a temperature of 115° C.

12. The method according to claim 9, wherein a temperature in the 90-to-400° C. range or in the 100-to-250° C. range, being made available by the low-temperature heat source.

13. The method according to claim 10, wherein the at least one substance having a fugacity exceeding 25 bar in the liquid phase at a temperature of 115° C.

14. The method according to claim 10, wherein a temperature in the 90-to-400° C. range or in the 100-to-250° C. range, being made available by the low-temperature heat source.

15. The method according to claim 1, wherein the low-temperature heat source makes temperatures in the 90-to-400° C. range available.

16. The method according to claim 1, wherein the low-temperature heat source makes temperatures in the 100-to-250° C. range available.

17. The method according to claim 1, wherein the low-temperature heat source is provided by means of geothermal energy or waste heat from an industrial process.
